(19) United States
(12) Patent Application Publication
(10) Pub. No.: US 2019/0347420 A1
(43) Pub. Date: Nov. 14, 2019

(54) METHOD AND SYSTEM FOR INSTALLING AND RUNNING UNTRUSTED APPLICATIONS

(71) Applicant: MICROSOFT TECHNOLOGY LICENSING, LLC, Redmond, WA (US)

(72) Inventors: Benjamin M. Schultz, Bellevue, WA (US); Matthew David Kurjanowicz, North Bend, WA (US); Ankit Srivastava, Seattle, WA (US); Ahmed Saruhan Karademir, Seattle, WA (US); Sudeep Kumar Ghosh, Kirkland, WA (US); Michael Trevor Pashniak, Newcastle, WA (US); Hari R. Pulapaka, Redmond, WA (US); Balaji Balasubramanyan, Redmond, WA (US); Tushar Suresh Sugandhi, Redmond, WA (US); Giridhar Viswanathan, Redmond, WA (US)

(21) Appl. No.: 15/977,680

(22) Filed: May 11, 2018

(51) Int. Cl. G06F 21/57; G06F 21/10; G06F 21/53; G06F 8/61; G06F 9/445; G06F 9/4401; G06F 9/455

(52) U.S. Cl. CPC G06F 21/57; G06F 21/10; G06F 21/53; G06F 2009/45587; G06F 9/44505; G06F 9/4406; G06F 9/45558; G06F 8/61

(57) ABSTRACT

Securely storing, installing, or launching applications. A method includes determining a trust characteristic or a license characteristic assigned to an application. When the trust characteristic or the license characteristic meets or exceeds a predetermined trust condition or a predetermined license condition, then the method includes at least one of storing, installing or launching the application in a first, more secure operating system while preventing the application from, being at least one of stored, installed or launched in a second, less secure operating system. When the trust characteristic or the license characteristic does not meet or exceed the predetermined trust condition or the predetermined license condition, then the method includes at least one of storing, installing or launching the application in the second less secure operating system while preventing the application from being at least one of stored, installed or launched in the first, more secure operating system.

### BACKGROUND

### Background and Relevant Art

Computers and computing systems have affected nearly every aspect of modern living. Computers are generally involved in work, recreation, healthcare, transportation, entertainment, household management, etc.

Containers and virtual machines (here, known as “guest operating systems” or “guests”) have great isolation capabilities. Guest operating systems typically run on a host computing system that has a host operating system and a number of different guest operating systems, where a security boundary isolates aspects of the host operating system and the guest operating systems to prevent the guest operating systems from accessing certain resources on the host. Thus, guest operating systems can help maintain security boundaries and improve compatibility. However, it can be difficult to determine when applications can be safely run on a host operating system, or when applications should be run on a guest operating system to make use of the isolation functionality.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing system comprising a host operating system and a guest operating system operating in the host operating system. The method includes acts for securely storing, installing, or launching applications. A method includes determining a trust characteristic or a license characteristic assigned to an application. When the trust characteristic or the license characteristic meets or exceeds a predetermined trust condition or a predetermined license condition, then the method includes at least one of storing, installing or launching the application in a first, more secure operating system while preventing the application from, being at least one of stored, installed or launched in a second, less secure operating system. When the trust characteristic or the license characteristic does not meet or exceed the predetermined trust condition or the predetermined license condition, then the method includes at least one of storing, installing or launching the application in the second less secure operating system while preventing the application from being at least one of stored, installed or launched in the first, more secure operating system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing system having a host operating system and a guest operating system configured to store, install, and/or launch applications based on trust factors;

FIG. 2 illustrates a computing system having a host operating system and a guest operating system configured to store, install, and/or launch applications based on licensing factors;

FIG. 3 illustrates a computing system having a host operating system and a guest operating system configured to store, install, and/or launch applications based on trust and/or licensing factors; and

FIG. 4 illustrates a method for securely storing, installing, or launching applications.

### DETAILED DESCRIPTION

Embodiments illustrated herein implement an improved computing system which provides improved security (such as malware protection) and/or application licensing control as compared to previous computing systems.

In some embodiments, a host operating system, in concert with licensing and/or policy information, determines where an application is stored or installed on the filesystems (i.e., on the host filesystem or in a guest filesystem). When the application is launched, the host operating system determines where the application is run (i.e., in the guest operating system or the host operating system). Determination of where an application is stored, installed, and/or launched is based on an evaluation of licensing and trust characteristics of applications.

For example, embodiments may include functionality for securely, storing, installing and/or launching applications. Embodiments determine a trust characteristic and/or a licensing characteristic applicable to an application or executable. When the applicable trust characteristic and/or licensing characteristic meets or exceeds a predetermined threshold trust condition, then the application can be stored, installed, and/or launched in a trusted operating system (such as directly on the host operating system). When the trust characteristic and/or licensing characteristic applicable to an application do not meet a particular threshold, the application will be (potentially) stored, installed, and/or launched in a guest operating system on the host. The guest operating system has limited capabilities. In particular, the guest operating system may be prevented from performing certain activities, accessing certain resources on the host, and so forth.

Note that the embodiments below illustrate the secure computing system in the context of a host operating system and one or more guest operating systems. In the examples below, it is generally assumed that the host operating system is a ‘secure’ operating system where only trusted applications are stored, installed, and/or launched (depending on the situation) and that the guest operating system is an ‘insecure’ operating system where untrusted applications can be stored, installed, and/or launched (depending on the situation). However, it should be appreciated that embodiments of the invention contemplate other scenarios. For example, there are scenarios in which the inverse is assumed, e.g. a ‘secure guest’ running on an ‘insecure’ host. Thus, the examples below should not be read to limit secure operating systems to host operating systems and insecure operating systems to guest or virtual operating systems operating on those host operating systems. Note that secure and insecure are relative terms. That is, a secure operating system has security measures, or a level of trust than an insecure operating system does not have. Thus, a secure operating system is more secure as compared to an insecure operating system. The insecure operating system may be insecure for one or more of a number of different reasons. For example, the insecure operating system may be more susceptible to infection by viruses or other malware than the secure operating system. The insecure operating system may have a lower level of data protection, such as encryption that is not as strong (or non-existent), less redundancy in data storage, not as protected by authentication and authorization measures, etc. as compared to the secure operating system. The insecure operating system may be more accessible to users than the secure operating system. For example, the secure operating system may only allow a limited set of certain users to use the operating system, whereas the insecure operating system may allow any user to use the operating system (or at least a larger set of users to use the operating system than are allowed to use the secure operating system). Etc.

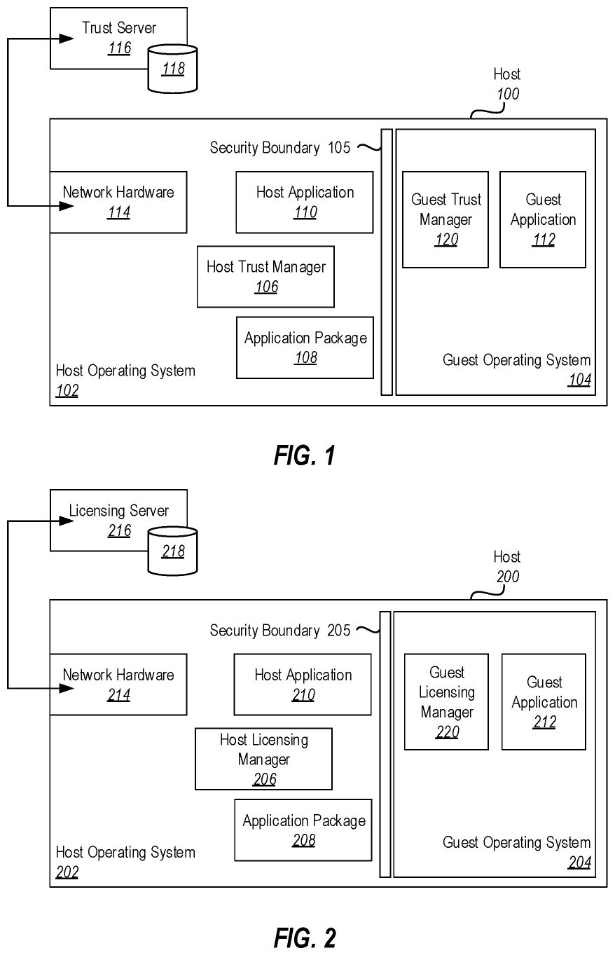

Referring now to FIG. 1, an example is illustrated. FIG. 1 illustrates a host 100. The host 100 may be a computing system with various hardware and software resources. For example, the host 100 may include various processors, memory, mass storage, networking hardware, video output hardware, displays, programmatic code, data stored in memory and/or the mass storage, or other computing resources. The host includes a host operating system 102 and a guest operating system 104. It should be noted (although not specifically shown), that typically a host 100 will include several different guest operating systems, inasmuch as efficiency can be obtained by sharing the hardware and software resources of the host 100 with multiple guest operating systems.

Applications installed in the host operating system 102 may have access to a greater portion of the resources available at the host 100. Indeed, some applications installed on the host operating system 102 may have virtually unlimited access to resources of the host 100.

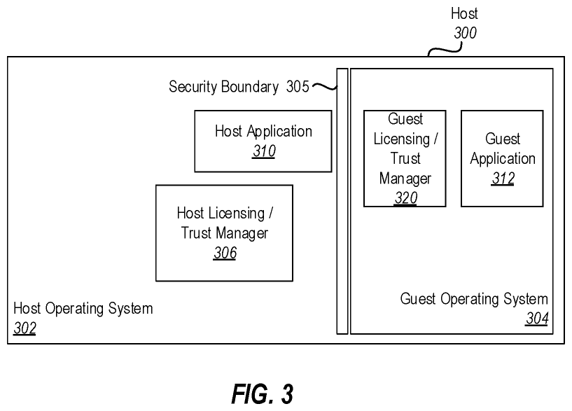

In contrast, applications installed in the guest operating system 104 will have much more limited access to the various resources of the computing system 100. This may be enforced by various boundaries which cordon off resources, such as various security boundaries, applied to the guest operating system 104. For example, FIG. 1 illustrates a security boundary 105. Corresponding security boundaries are shown at 205 and 305 in FIGS. 2 and 3. The security boundaries may include functionality for preventing unauthorized communications between the guest operating systems and the host operating systems.

Some embodiments may be configured to perform one or more of storing an application, installing an application, and/or launching an application in either the host operating system 102 or the guest operating system 104 based on trust characteristics and/or licensing characteristics. In the example illustrated in FIG. 1, storing, installing, and/or launching an application in an operating system is determined by trust characteristics. Additional examples will be illustrated herein where selecting an operating system on which to install an application is determined based on licensing characteristics. Further, examples will be illustrated where selecting an operating system on which to install an application is determined by both trust characteristics and licensing characteristics.

FIG. 1 illustrates a host trust manager 106. The host trust manager 106 can determine if an application has sufficient trust to be stored, installed, and/or launched on the host operating system 102. In particular, the host trust manager 106 can evaluate an application package 108 to determine various trust characteristics of the application package 108. An application package may be a package of executable code that has the ability to be stored in mass storage and/or memory. The application package can be installed using an installation process that stores data from the application package 108 in certain data structures that allow an application to be launched (i.e., executed). As used herein, examination of characteristics of an application may include examining characteristics of an application package used to install and/or launch the application. There are a nearly unlimited number of trust characteristics that the host trust manager 106 can examine.

For example, the host trust manager 106 can examine file marking, tagging, Access Control Lists (ACLs), and the like for the application package 106. File System flags, tags, ACLs, and the like can be used to persist a level of trust for the application package 108. As will be illustrated in more detail below, this marking can be used to determine where an application can be stored, installed, and/or launched. This may be performed by having, and evaluating, metadata in a header of an application package 108, an accompanying metadata file for an application package 108, an entry in an ACL, or by other appropriate means. Note that in some embodiments, an application may be stored or installed in the host operating system 102 but due to certain trust characteristics, only be launched in the guest operating system 104.

Note that some embodiments may have different and/or additional methods for persisting an application package's (and thus the application's) level of trust. In one embodiment, a database or ledger tracks an application package and stores the metadata in a cache on the host operating system. In another embodiment, this is tracked by a management service that may reside on the host operating system or on a remote computer that monitors the host operating system. Applications may be uniquely identified by a set of known characteristics including, but not limited to, application package name, folder name, version, size, checksum, location on disk, disk hardware unique identifiers, user identity who created/last modified the application, developer of the application, server or resource from which the application originated, application language, target processor architecture, user modifiable settings, target operating system, target hardware, other applications that the applications depend on, etc. The location (database, ledger, management service, etc.) that stores an application's level of trust then monitors (and enforces) operations on one or more host operating systems. In some embodiments this is tightly integrated into one or more filesystems. In other embodiments this is implemented as a set of filesystem extensions such as plug-ins and/or filters.

In some embodiments, isolated application packages are encrypted. From a security standpoint, application package encryption is a preferred method because it keeps any malware inert until the application package is decrypted. This prevents a user from accidently installing and/or launching an untrusted application in a trusted environment. Additionally, encryption can be a factor used in evaluating trust characteristics of an application package for determining where the application will be stored, installed, and/or launched. For example, an application package that is encrypted to a particular key may be trusted as it is known that the encryption key is maintained by a trusted entity. Thus, in one example applications encrypted with the particular encryption key would have a trust factor that allows the applications to be stored, installed, and/or launched the host operating system 102.

In some embodiments, trust characteristics may be determined by examining an external evaluation of the application package 108. For example, an anti-malware application can be configured to examine an application package to determine if the application package includes characteristics that would indicate that the application 108 is malware. If the anti-malware application determines that application package 108 includes features that indicate that the application package 108 is malware, then the application package would not meet trust characteristics necessary to store, install, and/or launch the application in the host operating system 102. In other scenarios, external databases including information about application packages may be consulted where those external databases include information for evaluating an application's trust characteristics. For example, a database may store lists of trustworthy applications and/or known untrustworthy applications.

In some embodiments, trust characteristics may be determined based on information about from where an application package is obtained. For example, if the application package 108 is downloaded from the Internet (or from particular locations on the Internet), then a trust characteristic associated with the application package may not meet the threshold to allow the application to be installed stored, installed, and/or launched on the host operating system 102.

In some embodiments, trust may be determined by multiple trust servers working in concert. These trust servers may reach consensus through a number of techniques such as using a quorum-based technique, an atomic commitment protocol, etc. The trust servers may use a processing method such as blockchain, in which the trust decision is managed as a transaction. Metadata about the trust determination may be stored in a ledger or other relevant data structures.

While not illustrated here, other factors may be used to determine if an application is trusted such that the application can be stored, installed, and/or launched in the host operating system 102.

Returning once again to the example in FIG. 1, if an application package 108 is determined to have sufficient trust characteristics to be stored, installed, and/or launched in the host operating system 102, the host trust manager 106 can allow the host application 110 to be stored, installed, and/or launched in the host operating system 102. For example, storing the application 110 in the host operating system 102 may include storing application package 108 in storage and/or memory allocated for the host operating system 102. Installing the application 110 on the host operating system 102 may include storing portions of the application package 108 in data structures for applications running on the host operating system 102. For example, certain files may be placed in the appropriate file paths (including, but not limited to, executable files, application configuration files, and data files), certain entries may be made in registries or other similar application management data structures, and the like. Launching the application 110 in the host operating system 102 may include loading portions of the application package into memory allocated to the host operating system 102 to allow processing allocated to the host operating system 102 to execute executable instructions from the memory. Note that some embodiments may have multiple host applications 110 and multiple application packages 108.

If a determination is made that the application does not meet trust characteristic thresholds, then the application will be (potentially) stored, installed, and/or launched in the guest operating system 104 as guest application 112. It should be noted, that in some embodiments when the application does not meet trust characteristic thresholds, the application may be nonetheless stored and/or installed on the host operating system 102, but will only be launched on the guest operating system 104. However, this is merely one illustrative example. It should be appreciated that in other embodiments, an application not meeting trust characteristic thresholds will be limited to be stored, installed, and launched on the guest operating system 104. Note that in some embodiments, guest operating system 104 will have multiple guest applications 112.

Note that in some embodiments, the host 100 may include network hardware 114 which allows the host 100 to contact external entities for obtaining trust policy. For example, the network hardware 114 may be connected to a trust server 116 which includes a policy store 118. The policy store 118 may store various policies related to trust. The policies can be transmitted through the network hardware 114 to the host 104. The host trust manager 106 references the policies to determine whether or not an application meets certain trust characteristic thresholds allowing the application to be stored, installed, and/or launched on the host operating 102. Note that in an alternative embodiment, the host trust manager 106 can provide trust characteristics to the trust server 116 for evaluation. The trust server 116 can indicate to the host trust manager 106 whether or not the trust characteristics meet the threshold conditions. Note that in some embodiments, trust server 116 may be composed of multiple distributed servers, and/or implemented as a cloud computing service.

FIG. 1 further illustrates a guest trust manager 120. In some embodiments, the guest trust manager 120 can determine that an application does not have sufficient trust characteristics to be stored, installed, and/or launched the guest operating system 104. Note that different guest operating systems may have different allowable trust characteristics, such that a given application may be prevented from being stored, installed, and/or launched on some guest operating systems, but allowed on others. In particular, a guest operating system may implement certain safeguards not implemented by other guest operating systems. Those safeguards can be used to allow certain applications to be stored, installed and/or launched on the guest operating system. However, in some embodiments, an application package may not have sufficient trust to be installed on any operating system associated with the host 100.

In some embodiments, the host 100 may be configured to intercept a command to store, install, and/or launch an application. In some embodiments, for untrusted applications a user will be presented with options to abort or launch the application in a secure isolated execution environment. Alternately, the application is directly launched in the secure isolated execution environment without requiring user choice.

Trusted applications can be launched on the host portion (i.e., a host operating system, sometimes referred to simply as a host) of the secure system. To accomplish this functionality, some embodiments of the secure system may further include an application programming interface (API) that probes the trust state of an application, such as by accessing application metadata. Alternatively or additionally, some embodiments of the secure system may further include an API such that applications and other software components can mark applications as untrusted (or alternatively or additionally as trusted). For example, in some embodiments, the application package 108 may have certain metadata associated with it that can be accessed and probed by the API.

Some embodiments of the secure system may include functionality that automatically marks applications as trusted and untrusted. In one scenario, a trust attribute may be configurable via enterprise policy and tracked as a part of application origin. For example, an enterprise user may download an application from a corporate server. This server may be identified by attributes such as location attributes (e.g. an IP address or URL), security attributes (e.g. an X.509 certificate or directory service listing such as active directory), etc. If this server and its identity are a part of the enterprise policy, the application that the user downloads from it will automatically be marked as trusted. In this same scenario, any application that originates from an untrusted source (e.g. a server, a removeable storage device, etc.) will be automatically marked as untrusted.

Alternatively or additionally the application, once downloaded from a source may be examined by diagnostic software (such as anti-virus, anti-malware, etc.) and trust level may be determined as a result. In some embodiments there may be multiple levels of trust. For example, if an application is from a known enterprise server and passes security inspection, it may be at the highest level of trust. If an application is from an unknown server and passes security inspection, it may have a middle level of trust. If an application fails security inspection, it may be untrusted. There are other additional or alternate mechanisms to assess an application for trust such as digital signatures, application identities, user identities, etc. In one embodiment, user A may send an application to user B. User B (or a software component on behalf of user B) does a background check via a 3^{rd} party service to determine the trust level before storing, installing, and/or launching the application from user A.

In some embodiments, when a trust level is applied to an archived (typically compressed) collection of one or more application components, e.g., .zip files, .cab files, etc., extracting application components from inside the archived collection preserves the trust level on all extracted application components. Thus, for example if the archived collection itself has a lower trust level, any application components extracted from that archived collection will have the same lower trust level automatically applied.

Similarly, when one or more application components are combined into a single archived collection, the generated archived collection preserves the lowest trust marking of its constituent application components. Some embodiments will optionally disallow creation of such an archive collection with a mix of files with different levels of trust marking.

Some embodiments of the secure system may include functionality that allows toggling of the trust attribute of an application. For example, some embodiments may include user interface elements, such as right-click context menus, or other user interface elements, that allow users to toggle a trust attribute of an application from trusted to untrusted and vice-versa.

Some embodiments of the secure system may include functionality to save untrusted applications from the guest to the host without caching data in the guest. In the guest, when a user or application saves an application package, one or more folders on the host operating system is available to save the application package. For security, the system calls to access the host filesystem may be restricted (e.g. via ACLs or other methods). These folder locations may not be accessible to a user or application on the host, or in some embodiments, the application components are automatically encrypted or altered so they cannot be installed or launched on the host.

Some embodiments of the secure system may include functionality to save untrusted application components from the guest to the host without exposing the host file system to the guest. For example, an interprocess communication (IPC) that does not expose the host file system can be used to communicate data from the guest to the host, where the host can manage where the data is stored. For example, embodiments may use sockets, message queues, pipes, shared memory, message passing, etc.

Some embodiments of the secure system may include functionality to save untrusted application components from the guest to the host while exposing a limited view of the host file system to the guest to improve the user experience. For example, various filter layers can be used to control which portion of the file system are exposed.

Some embodiments of the secure system may include a monitoring system which monitors storage, installation, and/or launch requests made to applications and determines how and where (e.g., in the host or the guest) to store, install, and/or launch these applications. For example, the monitoring system may cause untrusted applications to be launched on the guest while preventing such applications from being launched on the host, and trusted applications to be launched on the host while preventing such applications from being launched on the guest.

Some embodiments of the secure system may include an enforcement mechanism that blocks launching trusted applications in the guest and/or that blocks launching untrusted applications in the host.

In some embodiments, a specific user identity that has the privilege to run applications on host operating system 102 and/or guest operating system 104 is known to the trust server 116. This identity can be used considered as a part of a trust assessment. In one example, a user identity with low privilege may be associated with low trust and it will be determined that an application the user is attempting to install must only be installed in the guest operating system 104. In another example, an identity profiling service (not illustrated) provides additional context to the trust server 114. In some embodiments, the identity profiling service may monitor user actions and generate trust information based on this monitoring. For example, in one embodiment, this service informs trust server that the user identity has a history of trustworthy actions. This history will factor into the trust decision. The identity profiling service may be configured to use machine learning and other analysis techniques to identify if a user is account has been compromised.

In some embodiments, trust is periodically reassessed. This reassessment may be determined by a time interval, a notification, an event, etc. In some embodiments, an application software patch or upgrade may trigger the reassessment. In some embodiments a security compromise of the host 100 or the trust server 116 may trigger the reassessment.

Referring now to FIG. 2, alternative embodiments are illustrated. FIG. 2 illustrates an example where decisions about where to store, install, and/or launch an application on a host 200 are determined based on licensing considerations. In particular, an application may be licensed for use on a host operating system 202 or guest operating system 204.

An operating system may be selected for an application to be stored, installed, and/or launched based on a number of different various licensing conditions. For example, in some embodiments, selection of an operating system on which to store, install, and/or launch an application may be based on specific information in a license indicating the type of operating system on which the application should be stored, installed, and/or launched. Alternatively or additionally, an operating system may be selected based on the type of license granted.

As noted above, an operating system on which to store, install, and/or launch application may be based on specific information in a license. In the example illustrated in FIG. 2, a licensing server 216 having a license store 218 is connected through network hardware 214 to the host 200. When the host operating system 202 has an application package 208 to be launched, the host licensing manager 206 can obtain a license for the application package 208 from the licensing server 216. In some embodiments a license from the licensing server 216 will indicate specifically what operating systems the application can be launched on. For example, a license may indicate that the application is only to be launched on a guest operating system such as the guest operating system 204. FIG. 2 illustrates a guest application 212 on a guest operating system 204. In some embodiments the licensing server 216 may be composed of multiple distributed servers, and/or implemented as a cloud computing service.

Licensing for storage, installation, and/or launch on a guest operating system may be specified for any one of a number of different factors. For example, in some embodiments, a software developer may wish to provide software in different versions having different levels of functionality. In some embodiments, a license may specify that certain versions of the application are only to be launched in particular types of guest operating systems having limited functionality. In this way, the software developer can enforce application restrictions for lower tier versions of the software application. Thus, for example, if a lower tier version of the application has a particular feature that should be disabled, the license may specify that the application is only to be installed in a guest operating system that does not include the feature. In this way, the software developer can enforce strong restrictions on software functionality by restricting the types of operating systems on which the software can be launched (or stored or installed). Alternatively, a software developer may require the application to be installed on a host operating system. For example, this may occur when the application is an upper tier version of a software application. As noted, this may be specified in the license such that upper tier versions are prevented from being at least one of stored, installed, or launched on the guest operating system. This may be done as a form of quality control to prevent upper tier versions from being installed on less functional operating systems that are not able to provide all of the functionality available in the upper tier version of the application. In this way, the software developer can prevent the application from being used in a way that might result in a negative reputation for the upper tier version of the software application when users are unable to fully exploit the software application due to the application being installed on less functional operating systems.

Alternatively or additionally, short-lived licenses may specify that an application be installed on a guest operating system 204. In some embodiments, the guest operating system 204 may be specifically instantiated for such short-lived the licenses. For example, if an application is licensed as a short-lived application, installation of the application may cause the guest operating system 204 to be instantiated and the guest application 212 to be installed on the guest operating system 204. When the license expires for the application 212, the entire guest operating system 204 may be destroyed, thus effectively enforcing the short-lived license. In this example, the license may specify that the application 212 is only to be installed on a guest operating system that expires within the timeframe specified in the short-lived license.

Alternatively or additionally, event-based licenses may specify that an application be installed on a guest operating system 204. In some embodiments, the guest operating system 204 may be specifically instantiated for such event-based licenses. Similar to time-based licenses, when the event-based license expires, the entire guest operating system 204 may be destroyed, thus effectively enforcing the short-lived license. In this example, the license may expire due to a notification or event. In one scenario, guest application 212 implements a microservice to monitor an asset such as a stock or bond. When the asset is sold, monitoring is no longer required. As a result of receiving this notification guest operating system 204 is destroyed.

In an alternative or additional embodiment, an application may be stored, installed, and/or launched based on the type of license, without the license specifically indicating where the application should be a stored, installed, and/or launched. For example, as illustrated above, the license being for a lower tier version of a software application may be used to determine that the application should be installed on a guest operating system.

Some embodiments may install applications having short-lived license on the guest operating system 204 without the short-lived license specifying that the application should be installed guest operating system. Rather, embodiments may simply install any application associated with a short-lived license on guest operating systems.

FIG. 2 illustrates both a host licensing manager 206 and a guest licensing manager 220. The guest licensing manager 220 may include functionality for determining whether or not the guest application 212 can be installed on the guest operating system 204. Thus, it should be noted, that in some embodiments, licensing will not allow an application to be installed on either the host operating system 202 or the guest operating system 204. The guest licensing manager 220 can enforce these licensing requirements with respect to the guest operating system 204.

Note that the host licensing manager 206 and guest licensing manager 220 may be communicatively coupled to allow communication between the two licensing managers. This may be useful for a number of different reasons. In some embodiments this may be useful to ensure that licensing is not double counted, which might hamper the usability of the software application, cause an incurrence of unnecessary monetary costs to the end user, incur support costs to the application developer, etc. For example, a particular user of the host 200 may purchase a license from a software developer. In some embodiments, it may be desirable to allow that particular user to install the application on multiple operating systems so long as those operating systems reside on the same host. Thus, the user would be able to install an instance of the application 210 on the host operating system 202 and an instance of the application 212 on the guest operating system 204 without needing to acquire two licenses for the application. The host licensing manager 206 and guest licensing manager 220 could coordinate these installations in communication with the licensing server 216 to ensure that the user is in compliance with licensing agreements. In some embodiments, the licensing server 216 will pre-generate application licenses for guest application 212, enabling multiple instances of guest application 212 and guest operating system 204 to run on a given host operating system 202. In this embodiment, licensing server may know the unique identifiers of host operating system 202, a specific user identity that has the privilege to run applications on host operating system 202 and/or guest operating system 204. Note that in some embodiments, the guest licensing manager 220 will not communicate with the licensing server 216 directly, but rather will rely on the host licensing manager 206 to make appropriate decisions on behalf of the guest licensing manager 220.

The host licensing manager 206 and guest licensing manager 220 may communicate in a number of different fashions. For example, in some embodiments the host licensing manager 206 and guest licensing manager 220 may communicate through shared memory. Using shared memory allows for a secure communication channel to be established to prevent theft of licensing information. Alternatively or additionally, the host licensing manager 206 and guest licensing manager 220 communicate using direct messaging. Alternatively or additionally, the host licensing manager 206 and guest licensing manager 220 communicate using direct memory access (DMA). Etc.

Referring now to FIG. 3 an additional example is illustrated. In this example, decisions about where to store, install, and/or launch applications is based on both licensing and trust considerations. In particular, in some embodiments both a licensing characteristic and a trust characteristic must meet predetermined thresholds for the application 310 to be stored, installed, and/or launched on the host operating system 302. If an application cannot meet both thresholds, then the application 312 will be potentially installed on the guest operating system 304. Note that the various licensing and trust factors described above may be used in conjunction with one another in various ways to determine where an application will be stored, installed, and/or launched.

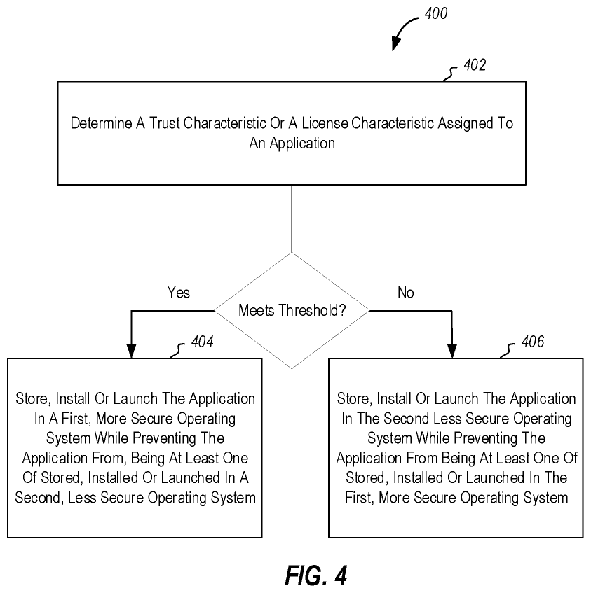

Referring now to FIG. 4, a method 400 is illustrated the method includes acts for securely storing, installing, or launching applications. The method 400 includes an act of determining a trust characteristic or a license characteristic assigned to an application (act 402). Various characteristics have been described in detail above.

When the trust characteristic or the license characteristic assigned to the application meets or exceeds a predetermined trust condition or the predetermined license condition, then the method 400 includes at least one of storing, installing or launching the application in a first, more secure operating system while preventing the application from, being at least one of stored, installed or launched in a second, less secure operating system (act 404). For example, FIG. 1-3 illustrate that an application can be installed on a host operating system (102, 202, 302) when certain trust and/or licensing conditions are met.

When the trust characteristic or the license characteristic assigned to the application does not meet or exceed the predetermined trust condition or the predetermined license condition, then the method 400 further includes at least one of storing, installing or launching the application in the second less secure operating system while preventing the application from being at least one of stored, installed or launched in the first, more secure operating system (act 402). FIGS. 1-3 above illustrate that applications not meeting certain trust and/or licensing conditions are stored, installed, and/or launched in a guest operating system (104, 204, 304).

The method 400 may further include launching the second, less secure operating system as a result of determining that the trust characteristic or the license characteristic assigned to the application does not meet or exceed the predetermined trust condition or the predetermined license condition. For example, a guest operating system may be specifically launched to host the application. In some embodiments, the guest operating system may be launched with specific characteristics so as to limit the functionality of the application for security or licensing reasons.

The method 400 may further include installing the application in the first, more secure operating system, but launching the application in the second, less secure operating system as a result of determining that the trust characteristic or the license characteristic assigned to the application meets or exceeds the predetermined trust condition. Thus, in some embodiments, even though the trust characteristics allow the application to be installed in a more secure operating system, the application may be nonetheless launched in a less secure operating system.

The method 400 may further include storing the application in the first, more secure operating system, but installing or launching the application in the second, less secure operating system as a result of determining that the trust characteristic or the license characteristic assigned to the application meets or exceeds the predetermined trust condition or the predetermined license condition. Thus, in some embodiments, even though the trust characteristics allow the application to be stored in a more secure operating system, the application may be nonetheless installed and/or launched in a less secure operating system.

The method 400 may further include installing the application in the first, more secure operating system, but launching the application in the second, less secure operating system as a result of determining that the trust characteristic or the license characteristic assigned to the application meets or exceeds the predetermined trust condition or the predetermined license condition and as a result of evaluating compatibility requirements. Thus, for example, certain applications may need certain characteristics for compatibility. Embodiments can create, or access guest operating system having these characteristics to promote compatibility between the application and operating system.

The method 400 may further include installing the application in the first, more secure operating system, but launching the application in the second, less secure operating system as a result of determining that the trust characteristic or the license characteristic assigned to the application meets or exceeds the predetermined trust condition or the predetermined license condition and as a result of evaluating content that the application will be handling. This may be the characteristics of the content, or the actual content. For example, if content is untrusted, some embodiments may launch the application ins a guest operating system to protect the host.

The method 400 may further include installing the application in the first, more secure operating system, but launching the application in the second, less secure operating system as a result of determining that the trust characteristic or the license characteristic assigned to the application meets or exceeds the predetermined trust condition or the predetermined license condition and as a result of evaluating a type for the application. For example, certain types of applications, such as browsers or other application that are highly susceptible to malware attacks, hijacking attacks, or other attacks, may be launched in guest operating system.

The method 400 may be performed where the license characteristic is based on trust characteristics for the application. For example, certain trust characteristics may be evaluated, and that evaluation can result in a license having certain characteristics. For example, an application may be determined to be untrusted or of a low-trust value. This information can cause a license to be issued with restricts the application only for use on guest operating system.

The method 400 may be performed where determining a condition of a trust characteristic assigned to an application comprises evaluating developer preferences. Thus, a developer can specifically specify whether a host operating system or a guest operating system should be used to store, install, and/or execute an application.

The method 400 may be performed where determining a condition of a trust characteristic assigned to an application comprises evaluating a trust characteristic associated with one or more files that will be accessed by the application. Thus, for example, the trust characteristic is not necessarily associated directly with the application, but rather to data that the application will be accessing.

The method 400 may be performed where and licensing characteristics are used to determine where an application should be stored, installed, and/or launched. In this particular example, the method acts of method 400 include determining a trust characteristic and a license characteristic assigned to an application. When the trust characteristic and the license characteristic assigned to the application meet or exceed the predetermined trust condition and the predetermined license condition, then the method 400 includes at least one of storing, installing or launching the application in a first, more secure operating system while preventing the application from, being at least one of stored, installed or launched in a second, less secure operating system. When the trust characteristic or the license characteristic assigned to the application does not meet or exceed the predetermined trust condition or the predetermined license condition, the method 400 includes at least one of storing, installing or launching the application in the second less secure operating system while preventing the application from being at least one of stored, installed or launched in the first, more secure operating system.

The method 400 may be practiced where determining a license characteristic comprises determining whether the license is a short-lived license or a long-lived license according to some predetermined criteria.

Note that some embodiments are implemented in container-based virtualization. Container-based virtualization is a type of virtualization that provides a lighter weight virtualization environment (consuming, for example, less memory, less processing power, and/or less of other resources), improved compatibility, and lower operational costs. In a containerized based configuration approach, various hierarchical configuration layers are used to configure entities such as containerized operating systems. Additionally, filters can be applied to configuration layers to accomplish the desired configuration for an entity. In particular, an entity, such as a container operating system kernel, can have different portions of different configuration layers exposed to it from a host operating system such that configuration from different configuration layers can be used to configure the containerized entity, but where the containerized entity operates as if it is running in its own pristine environment, even though it is using physical elements from the host operating system. Thus, a given configuration layer could be used as part of a configuration for multiple different containerized entities thus economizing storage, network, and compute resources by multi-purposing them for different container operating systems.

As intimated above, containers achieve their lightweight attributes through sharing aspects of the host operating system. This may include sharing, both local and/or remote, applications, sharing files and folders, sharing configuration, sharing, both physical and/or virtual devices, and sharing operating system services (sometimes referred to as daemons). In some environments, such as friendly multi-tenant hosting, systems may de-duplicate overlapping processes, enabling even more efficient resource utilization. Operating system services are a contributor to process overlap.

Lately, container technology has gained significant popularity. Developers and IT administrators are attracted to the benefits of containers, including software isolation and software compatibility. As containers are inexpensive to create and destroy, their lifecycle in some scenarios is much shorter than a typical operating system.

Further, the embodiments may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable media having stored thereon instructions that are executable by the one or more processors to configure the computer system to securely store, install, or launch applications, including instructions that are executable to configure the computer system to perform at least the following:
determining a trust characteristic or a license characteristic assigned to an application;
when the trust characteristic or the license characteristic assigned to the application meets or exceeds a predetermined trust condition or a predetermined license condition, then at least one of storing, installing or launching the application in a first, more secure operating system while preventing the application from, being at least one of stored, installed or launched in a second, less secure operating system; and
when the trust characteristic or the license characteristic assigned to the application does not meet or exceed the predetermined trust condition or the predetermined license condition, then at least one of storing, installing or launching the application in the second less secure operating system while preventing the application from being at least one of stored, installed or launched in the first, more secure operating system.

2. The computer system of claim 1, further comprising instructions that are executable to configure the computer system to launch the second, less secure operating system as a result of determining that the trust characteristic or the license characteristic assigned to the application does not meet or exceed the predetermined trust condition or the predetermined license condition.

3. The computer system of claim 1, further comprising instructions that are executable to configure the computer system install the application in the first, more secure operating system, but to launch the application in the second, less secure operating system as a result of determining that the trust characteristic or the license characteristic assigned to the application meets or exceeds the predetermined trust condition.

4. The computer system of claim 1, further comprising instructions that are executable to configure the computer system store the application in the first, more secure operating system, but to install or launch the application in the second, less secure operating system as a result of determining that the trust characteristic or the license characteristic assigned to the application meets or exceeds the predetermined trust condition or the predetermined license condition.

5. The computer system of claim 1, further comprising instructions that are executable to configure the computer system install the application in the first, more secure operating system, but to launch the application in the second, less secure operating system as a result of determining that the trust characteristic or the license characteristic assigned to the application meets or exceeds the predetermined trust condition or the predetermined license condition and as a result of evaluating compatibility requirements.

6. The computer system of claim 1, further comprising instructions that are executable to configure the computer system install the application in the first, more secure operating system, but to launch the application in the second, less secure operating system as a result of determining that the trust characteristic or the license characteristic assigned to the application meets or exceeds the predetermined trust condition or the predetermined license condition and as a result of evaluating content that the application will be handling.

7. The computer system of claim 1, further comprising instructions that are executable to configure the computer system install the application in the first, more secure operating system, but to launch the application in the second, less secure operating system as a result of determining that the trust characteristic or the license characteristic assigned to the application meets or exceeds the predetermined trust condition or the predetermined license condition and as a result of evaluating a type for the application.

8. The computer system of claim 1, wherein the license characteristic is based on trust characteristics for the application.

9. The computer system of claim 1, wherein determining a condition of a trust characteristic assigned to an application comprises evaluating developer preferences.

10. The computer system of claim 1, wherein determining a condition of a trust characteristic assigned to an application comprises evaluating a trust characteristic associated with one or more files that will be accessed by the application.

11. The computer system of claim 1, wherein the instructions that are executable configure the computer system to perform at least the following:
determining a trust characteristic and a license characteristic assigned to an application;
when the trust characteristic and the license characteristic assigned to the application meet or exceed the predetermined trust condition and the predetermined license condition, then at least one of storing, installing or launching the application in a first, more secure operating system while preventing the application from, being at least one of stored, installed or launched in a second, less secure operating system; and
when the trust characteristic or the license characteristic assigned to the application does not meet or exceed the predetermined trust condition or the predetermined license condition, then at least one of storing, installing or launching the application in the second less secure operating system while preventing the application from being at least one of stored, installed or launched in the first, more secure operating system.

12. The computer system of claim 1, wherein determining a license characteristic comprises determining whether the license is a short-lived license or a long-lived license according to some predetermined criteria.

13. The computer system of claim 1, wherein determining a condition of a trust characteristic assigned to an application comprises evaluating a trust characteristic determined by a plurality of trust servers working in concert.

14. The computer system of claim 1, wherein determining a condition of a trust characteristic assigned to an application comprises evaluating a trust characteristic associated with a specific user identity for a user attempting to store, install, or launch the application.

15. The computer system of claim 1, wherein the license characteristic is based on an event-based license that expires as the result of an event occurring.

16. The computer system of claim 1, wherein the license characteristic is based on a pre-generated application license.

17. The computer system of claim 1, wherein the instructions that are executable configure the computer system to cause at least one of a first operating system licensing manager a second operating system licensing manager to ensure multiple licenses are no acquired for the same application stored, installed, or launched on a single host computing system.

18. In a computing system comprising at least a first more secure operating system and a second less secure operating system operating, a method of securely storing, installing, or launching applications, the method comprising:
determining a trust characteristic or a license characteristic assigned to an application;
when the trust characteristic or the license characteristic assigned to the application meets or exceeds a predetermined trust condition or a predetermined license condition, then at least one of storing, installing or launching the application in a first, more secure operating system while preventing the application from, being at least one of stored, installed or launched in a second, less secure operating system; and
when the trust characteristic or the license characteristic assigned to the application does not meet or exceed the predetermined trust condition or the predetermined license condition, then at least one of storing, installing or launching the application in the second less secure operating system while preventing the application from being at least one of stored, installed or launched in the first, more secure operating system.

19. The method of claim 18, further comprising launching the second, less secure operating system as a result of determining that the trust characteristic or the license characteristic assigned to the application does not meet or exceed the predetermined trust condition or the predetermined license condition.

20. A computer system comprising:
a host operating system;
at least one guest operating system implemented on the host operating system; and
a monitoring system configured to monitor at least one of application storage, installation, or launching wherein the monitoring system is configured to determine trust characteristics or licensing characteristics assigned to an application, wherein the monitoring system is further configured to:
when the trust characteristic or the license characteristic assigned to the application meets or exceeds a predetermined trust condition or a predetermined license condition, then at least one of storing, installing or launching the application in a first, more secure operating system while preventing the application from, being at least one of stored, installed or launched in a second, less secure operating system; and
when the trust characteristic or the license characteristic assigned to the application does not meet or exceed the predetermined trust condition or the predetermined license condition, then at least one of storing, installing or launching the application in the second less secure operating system while preventing the application from being at least one of stored, installed or launched in the first, more secure operating system.
